(19) United States
(12) Patent Application Publication
(10) Pub. No.: US 2025/0117213 A1
(43) Pub. Date: Apr. 10, 2025

(54) SEQUENCE PROGRAM DISPLAY DEVICE AND COMPUTER-READABLE STORAGE MEDIUM

(71) Applicant: FANUC CORPORATION, Yamanashi (JP)

(72) Inventor: Yuuki IKEDA, Yamanashi (JP)

(21) Appl. No.: 18/729,163

(22) PCT Filed: Jan. 31, 2022
(86) PCT No.: PCT/JP2022/003577

§ 371 Date: Jul. 15, 2024

(51) Int. Cl. G06F 8/70

(52) U.S. Cl. CPC G06F 8/70

(57) ABSTRACT

Provided is a sequence program display device in which a correspondence between variable names conforming to a first notation and symbol names conforming to a second notation is stored and, through execution by one or more processors, a sequence program in which variable names conforming to the first notation are written is obtained, the variable names included in the sequence program are replaced by symbol names conforming to the second notation, and the sequence program with the symbol names conforming to the second notation is displayed.

### TECHNICAL FIELD

The present invention relates to a sequence program display device and a computer-readable storage medium.

### BACKGROUND ART

A programmable logic controller (PLC) is a control device for manufacturing equipment and others. The PLC acquires signals from an input device, processes the signals according to a program, and controls an output device connected to the PLC.

The PLC conducts sequence control. The sequence control is a control method for sequentially implementing each step of control according to a predefined sequence or procedure. Programs used in the PLC are called sequence programs.

There are several languages for sequence programs. Representative languages include ladder language, structured text (ST) language, function block diagram (FBD) language, and sequential function chart (SFC) language. Even the same ladder language may have different specifications depending on vendors.

In creating a ladder program, a diagram simulating a circuit using relay contacts and coils is displayed, and a symbol of a virtual device is placed on each contact and coil. Characters displayed in information of an input symbol represent an input device itself or an address to which signals from the input device are input. A device comment in a correspondence with the input device may be displayed below the symbol of the input device (see e.g. Patent Literature 1).

### PRIOR ART DOCUMENT

### Patent Literature

[Patent Literature 1] Japanese Patent Laid-Open Publication No. 2020-134986

### SUMMARY OF THE INVENTION

### Problems to be Solved by the Invention

In the ladder program, a symbol name can be given to the symbol of the virtual device. A rule for naming the symbol in the ladder program follows electric circuit notation.

However, currently, there is a move to unify variable names according to the IEC standards (IEC61131-3). Symbol names following electronic circuit notation may not conform to the IEC standards. Furthermore, symbols, such as “+” and “*”, have meaning as text in the ST language which is a text-based language, so that the symbol names following the electronic circuit notation may not be used for grammatical reasons.

The use of variable names conforming to the IEC standards increases compatibility between the programs. However, some users are familiar with the notation of conventional electrical circuits, and some users want to continue programming by the notation created in the past.

In the field of sequence program, a development environment for creating programs that conforms to the standards while maintaining user operability is desired.

### Means for Solving the Problem

One aspect of the present disclosure is a sequence program display device that includes: a name storage unit that stores correspondences between variable names conforming to first notation and symbol names conforming to second notation; a program acquisition unit that acquires a sequence program described by the variable names conforming to the first notation; a name replacement unit that replaces the variable names included in the sequence program with the symbol names; and a program display unit that displays the sequence program using the symbol names.

One aspect of the present disclosure is a storage medium for storing computer-readable commands that stores correspondences between variable names that conform to first notation and symbol names that conform to second notation, in which the one or more processors execute the commands to: acquire a sequence program described by variable names conforming to the first notation; replace the variable names included in the sequence program with symbol names that conform to the second notation; and display the sequence program with the symbol names conforming to the second notation.

### EFFECT OF THE INVENTION

According to one aspect of the present invention, a program development environment that conforms to the standards while maintaining the user operability can be provided.

### BRIEF DESCRIPTION OF THE DRAWINGS

FIG. 1 is a block diagram showing a sequence program display device according to a first disclosure;

FIG. 2 shows an example of a sequence program display screen;

FIG. 3 shows a table describing requirements of IEC standards;

FIG. 4 shows an example of a correspondence table between variable names and symbol names;

FIG. 5 is a block diagram of a sequence program display device according to a second disclosure;

FIG. 6 shows an example of a setting screen for the variable names and the symbol names;

FIG. 7 shows an example of a replacement table;

FIG. 8 is a flowchart illustrating an operation of the sequence program display device according to the second disclosure;

FIG. 9A shows an example of a ladder program to be stored in a program storage unit;

FIG. 9B shows an example of a correspondence table between the symbol names and the variable names;

FIG. 9C shows an example of a ladder program to be displayed on an edit screen;

FIG. 10A shows an example of the edit screen of the ladder program;

FIG. 10B shows variable names and symbol names to be added to the correspondence table;

FIG. 10C shows an example of the ladder program to be stored in the program storage unit;

FIG. 10D shows an example of the edit screen of the ladder program after establishing correspondences between the names;

FIG. 11A shows an example of a structured text program using variable names;

FIG. 11B shows an example of a display screen for a structured text program using symbol names; and

FIG. 12 shows a hardware configuration of the sequence program display device.

### MODE FOR CARRYING THE INVENTION

### First Disclosure

A description will now be made about a sequence program display device 100 according to a first disclosure.

The sequence program display device 100 of the first disclosure is installed in an information processing device which displays and edits a sequence program. The information processing device includes, but is not limited to, a numerical controller, a personal computer (PC) and the like.

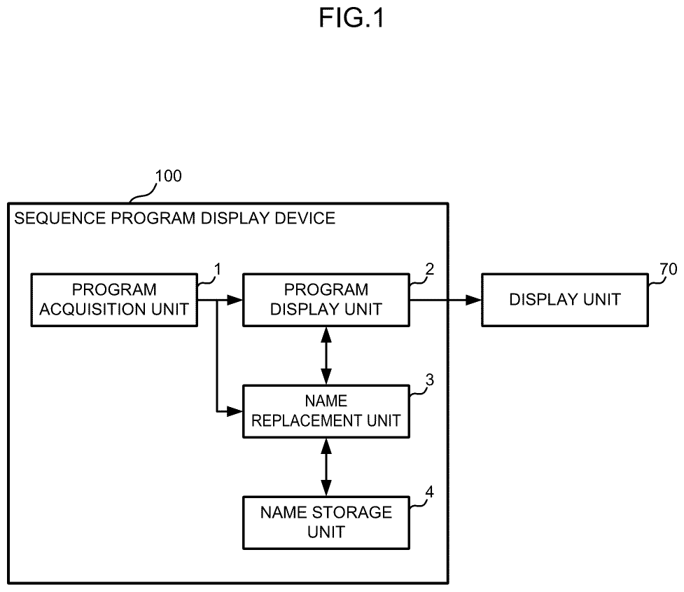

FIG. 1 is a block diagram of the sequence program display device 100 of the first disclosure.

The sequence program display device 100 of the first disclosure includes a program acquisition unit 1, a program display unit 2, a name replacement unit 3 and a name storage unit 4.

The program acquisition unit 1 is configured to acquire a sequence program. The sequence program may be input by a user through program edition, or an existing sequence program may be acquired.

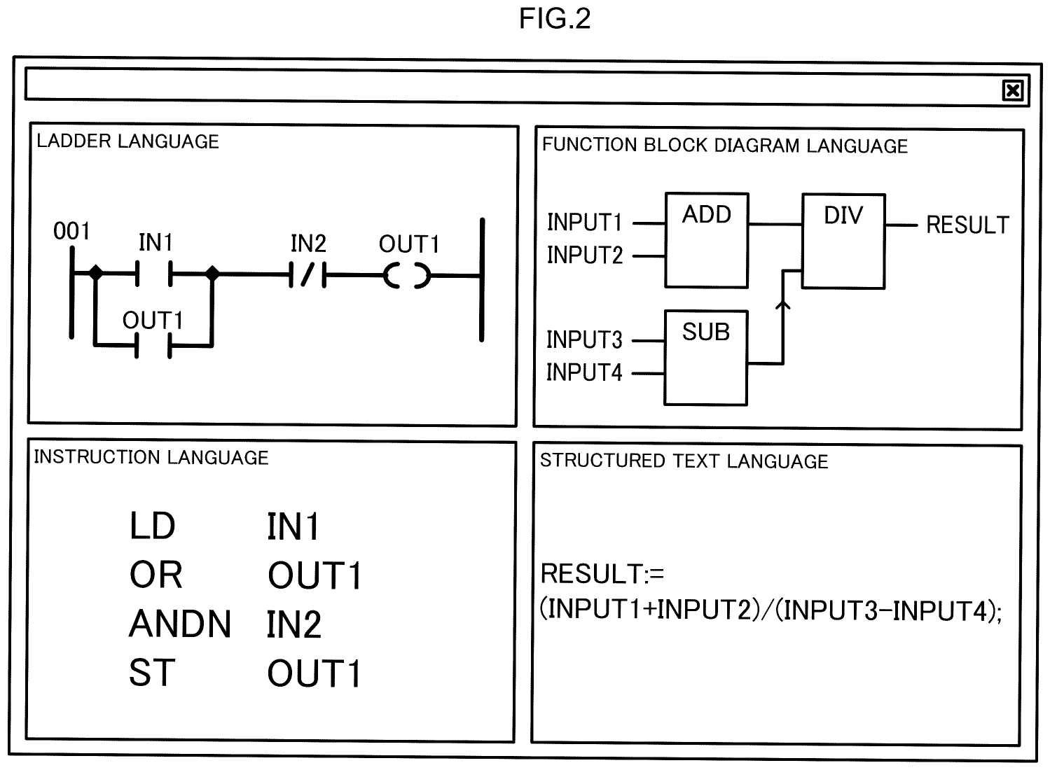

The program display unit 2 is configured to display the sequence program on a display unit 70, such as a display. FIG. 2 shows an example of a sequence program display screen. The display screen in FIG. 2 is split into four display areas, and the display areas display programs written in ladder language, structured text language, function block diagram language and instruction language, respectively.

The ladder language is in a graphic format which is conventionally used widely in Japan and suitable for writing sequence processing.

The structured text language is in a text format which is suitable for numerical computation, as well as branching control for IF and FOR statements.

The function block diagram language is in a graphic format which connects pins of function blocks to describe them like an electronic circuit diagram. This language is suitable for continuous analog signals and enables a user to visually check an operation.

The instruction language is in a text format which is similar to computer assembly language and describes a series of commands as a list. This language is effective in decreasing in size and increasing in speed of applications.

The number of language types to be displayed on the sequence program display screen is not necessarily four, and may be one or more.

It is preferable that the sequence program is written in conformity with the IEC standards. In the IEC standards, program names, function block names, function names, variable names, and data format names are collectively called identifiers.

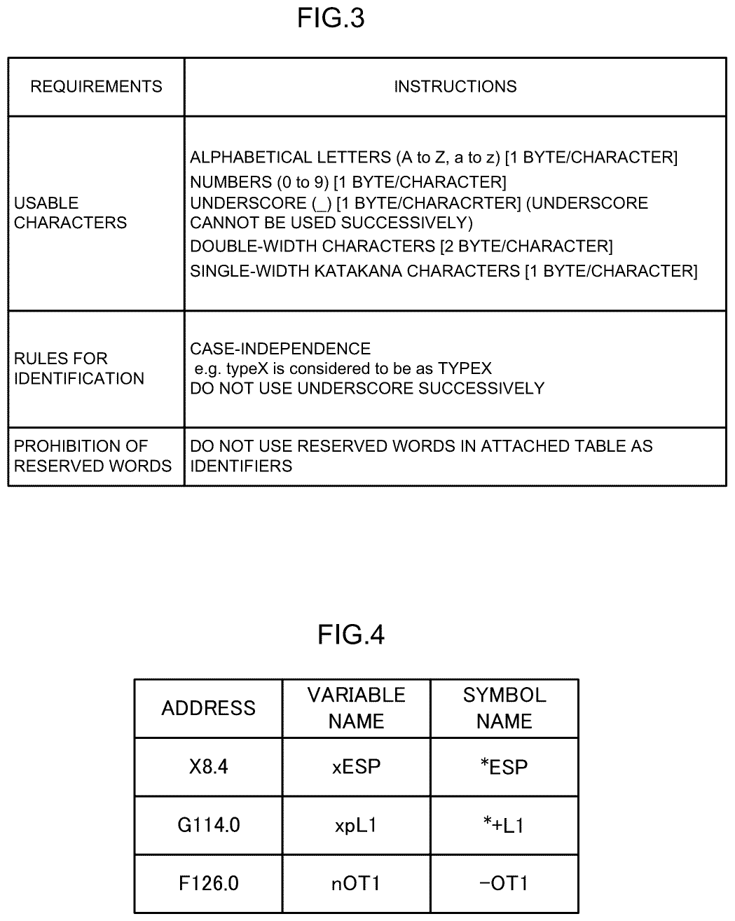

In the IEC standards, the identifiers need to satisfy requirements shown in FIG. 3.

More specifically, usable characters include alphabetical letters (A to Z, a to z) [1 byte/character], numbers (0 to 9) [1 byte/character], and underscore (_) [1 byte/character] (but the underscore cannot be used successively). It is case-independence. The use of reserved words is prohibited.

The program acquisition unit 1 acquires a sequence program currently being edited or an existing program created in the past. The sequence programs acquired by the program acquisition unit 1 are described by variable names, which will be described later.

The name storage unit 4 is configured to store addresses, symbol names and variable names by establishing correspondences between them. The addresses are numbers assigned to input/output relays, internal auxiliary relays, timers, counters and the like that can be used in a sequence program. At least the variable names are assigned to variables, and the addresses may also be assigned to the variables.

Some addresses may also be assigned symbol names. The symbol names follow the electronic circuit notation. In the present disclosure, the variable names in the sequence program are replaced with and displayed in the symbol names, so as to improve the visibility for users who are familiar with programming using the electronic circuit notation.

The name storage unit 4 stores a correspondence table between the variable names and the symbol names. FIG. 4 shows an example of the correspondence table. In the name storage unit 4 shown in FIG. 4, a variable name “xESP” and a symbol name “*ESP” are assigned to an address “X8.4”. In addition to that, a variable name “xpL1” and a symbol name “*+L1” are assigned to an address “G114.0”, and a variable name “nOT1” and a symbol name “-OT1” are assigned to an address “F126.0”.

The name replacement unit 3 is configured to replace the type of name to be displayed. The name replacement unit replaces, for example, the type of name to be displayed for each language of the sequence program. More specifically, it is assumed that a sequence program in the ladder language is displayed by replacing it with symbolic names.

As described above, the sequence program display device 100 of the first disclosure stores the variable name conforming to the unified IEC standards and the symbol name conforming to the electronic circuit notation as the names of the addresses in the sequence program.

The sequence program is stored with the variable names based on the IEC standards and displayed, if needed, through replacement with the electronic circuit notation. This improves the visibility for the users familiar with the electronic circuit notation.

### Second Disclosure

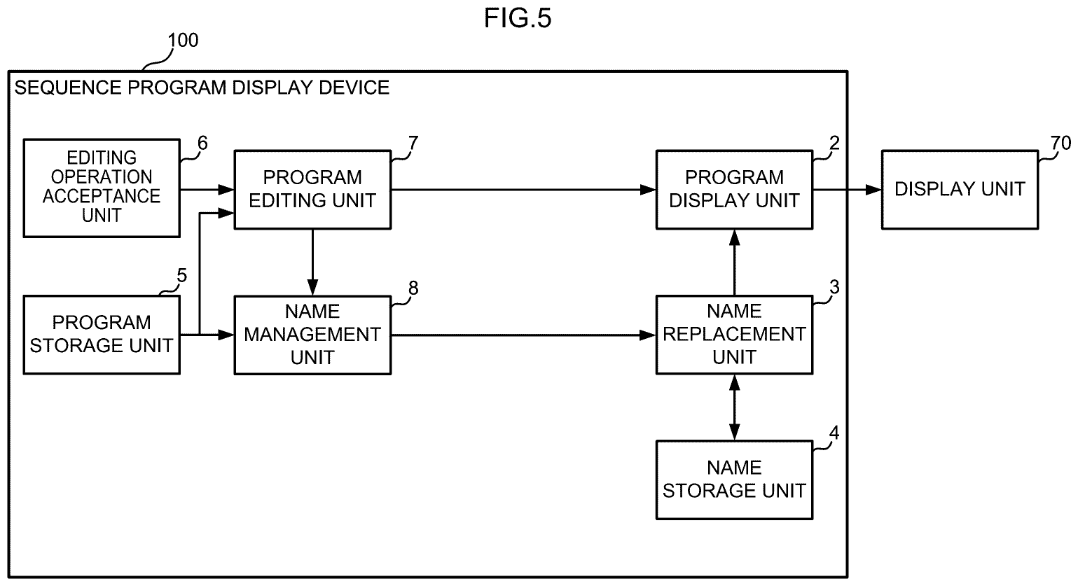

FIG. 5 shows a sequence program display device 100 according to a second disclosure.

The sequence program display device 100 of the second disclosure includes a program storage unit 5, a program display unit 2, a name replacement unit 3, a name storage unit 4, an editing operation acceptance unit 6, a program editing unit 7 and a name management unit 8.

The sequence program display unit 100 of the second disclosure is configured to create a correspondence table between variable names that conform to the IEC standards and symbol names that conform to the electronic circuit notation.

The program storage unit 5 is configured to store existing sequence programs. The sequence programs are written in one or more languages. The addresses in the sequence programs have variable names that conform to the IEC standards or symbol names descried according to the electronic circuit notation, or have both of them.

The name replacement unit 3 is configured to replace the types of names to be displayed. For example, the name replacement unit 3 replaces the type of name to be displayed for each language. More specifically, a sequence program in ladder language is displayed by replacing with symbol names, and sequence programs in languages other than the ladder language are displayed without replacing with the symbol names.

The name storage unit 4 is configured to store addresses, symbol names and variable names by establishing correspondences between them. As described above, the addresses are numbers assigned to the input/output relays, the internal auxiliary relays, the timers, the counters and the like that can be used in a sequence program. At least the variable names are assigned to the addresses. The symbol names may also be assigned to the addresses. The symbol names follow the electronic circuit notation.

The program display unit 2 is configured to display sequence programs on a display unit, such as a display. The sequence programs can be displayed in a plurality of languages. Furthermore, ladder language can be inserted into structured text language, a ladder language output can be input in a function block, and the plurality of languages can be displayed in combination.

In a case where variable names of a sequence program and names to be displayed on a screen are replaced with symbol names, the fact that the names have been replaced may be visually expressed by decorating the replaced names. Decoration manner includes, for instance, letter color, background color, presence or absence of a frame, and pop-up on mouseover.

The editing operation acceptance unit 6 is configured to accept sequence program editing. As described above, the sequence program can be written in multiple languages. The notation may differ depending on the languages, and may also differ depending on a manufacturer of a programmable logic controller (PLC) that operates the sequence program. The name management unit 8, which will be described later, replaces addresses with names that conform to the IEC standards.

The name management unit 8 is configured to create a correspondence table and replace names in the sequence program.

In the creation of the correspondence table, symbol names in the sequence program are replaced with variable names conforming to the IEC standards and stored in the program storage unit 5, and the symbol names are brought into correspondence with the variable names.

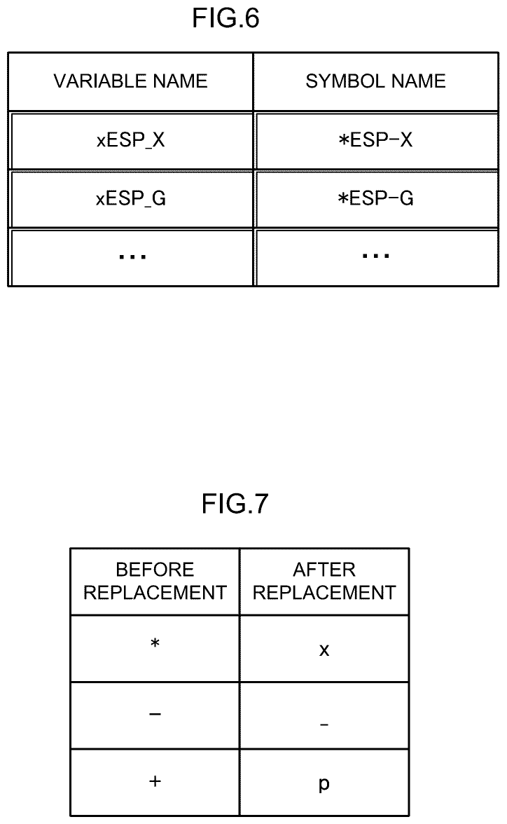

More specifically, the name management unit 8 reads the symbol names from the sequence program, determines whether the symbol names conform to the IEC standards, and when symbol names in a ladder program do not conform to the IEC standards, allows a user to register variable names that conform to the IEC standards. FIG. 6 shows an example of a setting screen for the variable names and the symbol names. The setting screen can be used to bring the symbol names into correspondence with the variable names.

The name management unit 8 also replaces the names in the sequence program. The name management unit 8 refers to the correspondence table when an existing sequence program is described by symbol names, when symbol names are input during editing a sequence program and so on, so as to replace the symbol names in the sequence program with variable names and store it in the program storage unit 5.

The name management unit 8 may have a replacement table for characters and character strings.

FIG. 7 shows an example of the replacement table. As described above, the IEC standards have a rule that symbols other than underscores cannot be used. The replacement table defines characters to be replaced for characters that are not allowed to be used in the IEC standards. The replacement table in FIG. 7 shows that a character “*” is replaced with a character “x”, a character “-” is replaced with a character “_”, and a character “+” is replaced with a letter “p”. According to the replacement table, a symbol name “*ESP-X” is replaced with a variable name “xESP_X”. Establishment of correspondences between the symbol names and the variable names may be conducted automatically by the name management unit 8, or it may be conducted manually by the user by visually checking the variable names.

The replacement table may incorporate a naming rule.

Under the predefined naming rule, it is possible to estimate meaning, function and usage of variables to some extent, and the efficiency of debugging, correction and incremental development can be improved. In a case where more than one person works on development, naming variables under a uniform rule can improve readability and visibility of each other's codes, and thereby development efficiency and maintainability can be increased.

By including the replacement table in the naming rule, the variable names can be created automatically according to the naming rule and the candidate names for the variable names according to the naming rule can be presented to the user.

The name replacement unit 3 replaces a name to be displayed according to the language of the sequence program displayed on the display unit 70. More specifically, when the sequence program in the ladder language is displayed, the displayed name is replaced with the symbol name.

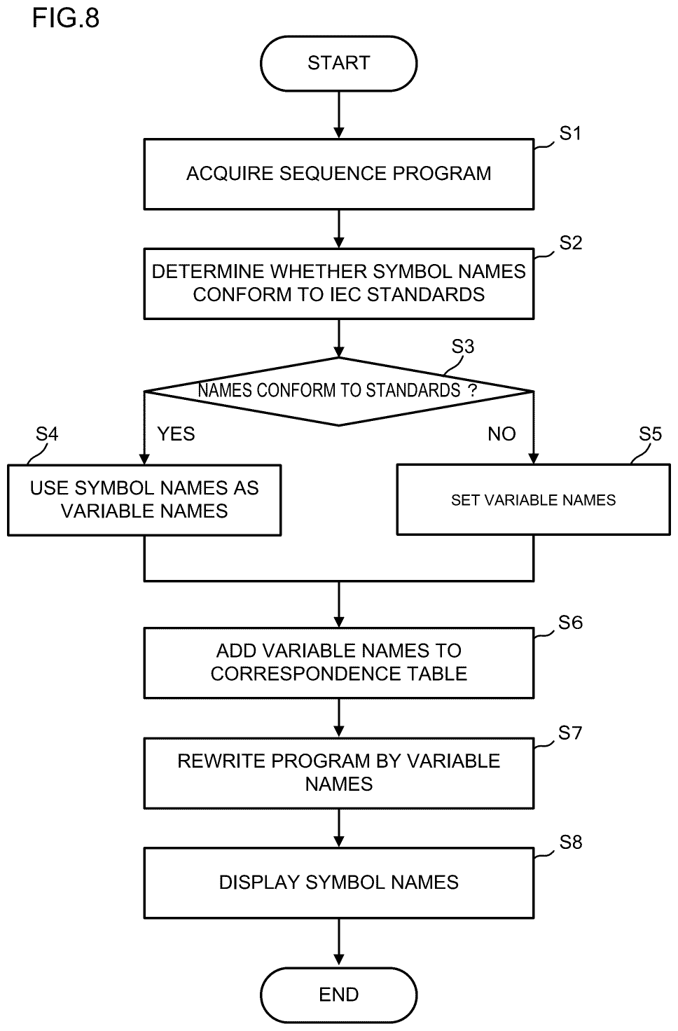

FIG. 8 is a flowchart illustrating an operation of the sequence program display device 100 of the second disclosure.

The sequence program display device 100 acquires a sequence program from the editing operation acceptance unit 6 or the program storage unit 5 (step S1). When a symbol name is input by an editing operation or when there is the symbol name in an existing program, the name management unit 8 determines whether or not the symbol name conforms to the IEC standards (step S2).

When the symbol name conforms to the IEC standards (step S3: Yes), the name management unit 8 uses the symbol name as a variable name without replacing it (step S4). When the symbol name does not conform to the IEC standards (step S3: No), the name management unit 8 displays a setting screen for variable names shown in FIG. 6, for instance, to allow a user to set the variable name (step S5).

When the user sets the variable name, the name storage unit 4 adds the set symbol name and the variable name to a correspondence table (step S6). In step S5, a replacement table may be used to replace the symbol name, and presents the user the replaced name as a candidate for the variable name conforming to the IEC standards to thereby accept a selection made by the user.

The name management unit 8 rewrites the name given to an address in the sequence program into a variable name that conforms to the IEC standards, and stores the rewritten name in the program storage unit 5 (step S7). At this time, the name given to the address in the sequence program is rewritten by the variable name conforming to the IEC standards, but the display screen for the sequence program shows a symbol name that conforms to electronic circuit notation (step S8).

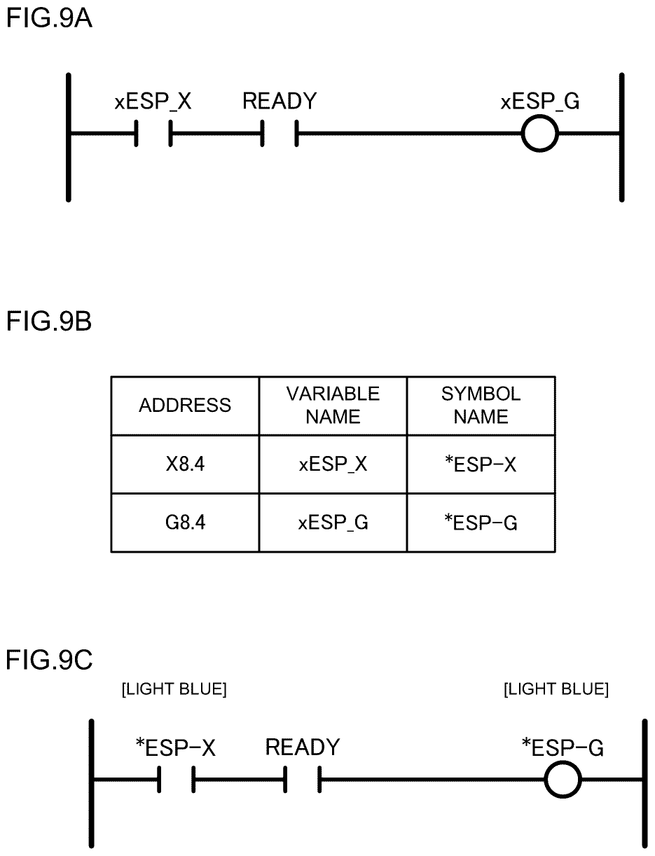

With reference to FIGS. 9 to 11, a description will be made about an embodiment of the operation of the sequence program display device 100.

(1) An example of replacing the display of an existing sequence program will be described. In this example, variable names are used to write the sequence program, and it is assumed that correspondences between symbol names and variable names has been established. The display replacement is performed in both the sequence program display device according to the first disclosure and the sequence program display device according to the second disclosure.

FIG. 9A shows a ladder program to be stored in the program storage unit 5. In this ladder program, the variable name of an a-terminal on an input bus bar side is “xESP_X”, the variable name of another a-terminal is “READY”, and the variable name of an output on an output bus bar side is “xESP_G”.

The name replacement unit 3 replaces the names to be displayed according to the language of the sequence program displayed on the display unit 70. In this embodiment, the name of the sequence program written in ladder language is replaced. FIG. 9B shows an example of a correspondence table between symbol names and variable names. In this correspondence table, the variable name “xESP_X” of the address “x8.4” is replaced with the symbol name “*ESP-X”, and the variable name “xESP_G” of the address “G8.4” is replaced with the symbol name “*ESP-G”.

The name replacement unit 3 replaces the variable names in the sequence program written in the ladder language with symbol names, and the program display unit 2 displays the replaced symbol names on an edit screen of the sequence program.

FIG. 9C shows the ladder program displayed on the edit screen. In FIG. 9C, the variable name “xESP_X” of an a-contact on the input bus bar side is displayed in the symbol name “*ESP-X”. Furthermore, the variable name “xESP_G” of the output on the output bus bar side is displayed in the symbol name “*ESP-G”.

The display screen in FIG. 9C displays the symbol name “*ESP-X” and the symbol name “*ESP-G” in light blue. The display screen in FIG. 9C uses the letter color for the symbol names to suggest that the symbol names are different from the variable names in the sequence program. In addition to the letter color, background color of the characters and frames around the characters may be displayed to point out differences between the displayed symbol names and the variable names in the sequence program.

(2) Another example will now be described, in which a correspondence table between the symbol names and the variable names is created during editing the sequence program and rewriting of the sequence program is conducted.

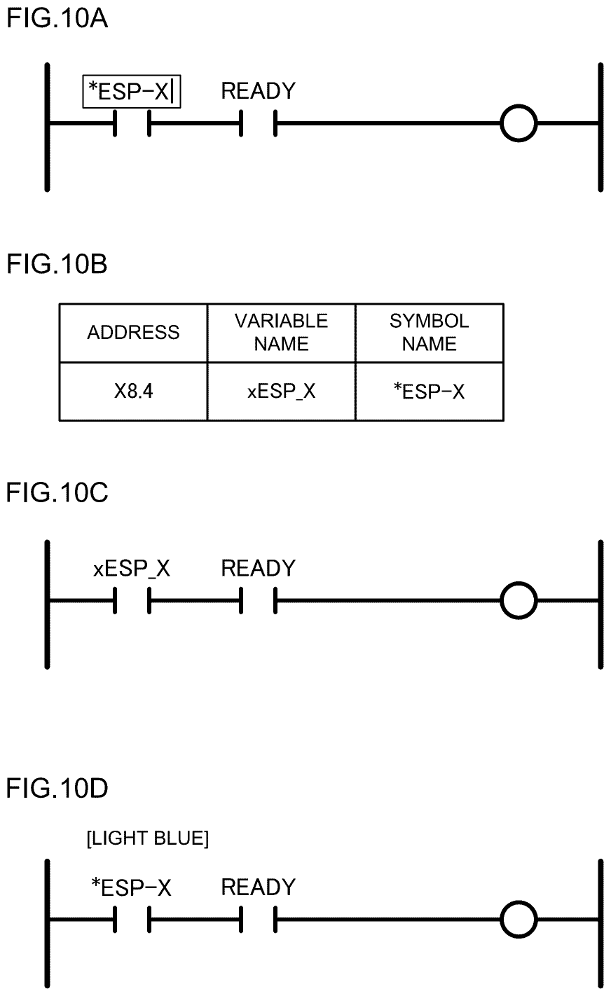

FIG. 10A shows an example of an edit screen of the ladder program. In the ladder program being edited, the symbol name “*ESP-X” is input to the a-terminal on the input bus bar side. The name management unit 8 determines whether or not the symbol name input to the edit screen conforms to the IEC standards. The symbol name “READY” is used as a variable name without being replaced because it can be used in the IEC standards. Since the symbols “*” and “-” cannot be used in the IEC standards, the name management unit 8 prompts the user to input the variable name. For inputting the variable name, for instance, the setting screen for the variable names and the symbol names shown in FIG. 6 is displayed. Thus, the user sets the variable name that corresponds to the symbol name. The correspondence between the symbol name and the variable name is added to the correspondence table.

FIG. 10B shows an example of the variable name, the symbol name and the address added to the correspondence table.

The name management unit 8 rewrites the symbol names in the ladder program into the variable names to store the program in the program storage unit 5. The ladder program stored in the program storage unit 5 is as shown in FIG. 10C. In the program, the a-contact on the input bus bar side is rewritten into the variable name “xESP_X”.

FIG. 10D shows an edit screen of the ladder program after establishing the correspondences between the names. The edit screen displays the symbol name “*ESP-X” input by the user without being replaced. The text of the symbol name is indicated in light blue so as to point out the difference between the variable name and the symbol name.

The replacement of the symbol names with the variable names may be conducted automatically by using the replacement table shown in FIG. 7. The replacement table may also be used to automatically create candidate names for a variable name to be replaced, and present the created candidate names to the user to allow the user to select a variable name from the presented candidate names.

(3) An example of replacement of display in structured text language will now be described. It is assumed that the correspondences between symbol names and variable names have been established.

A structured text program is stored in the program storage unit 5. The structured text program stored in the program storage unit 5 is described by the variable names that conform to the IEC standards.

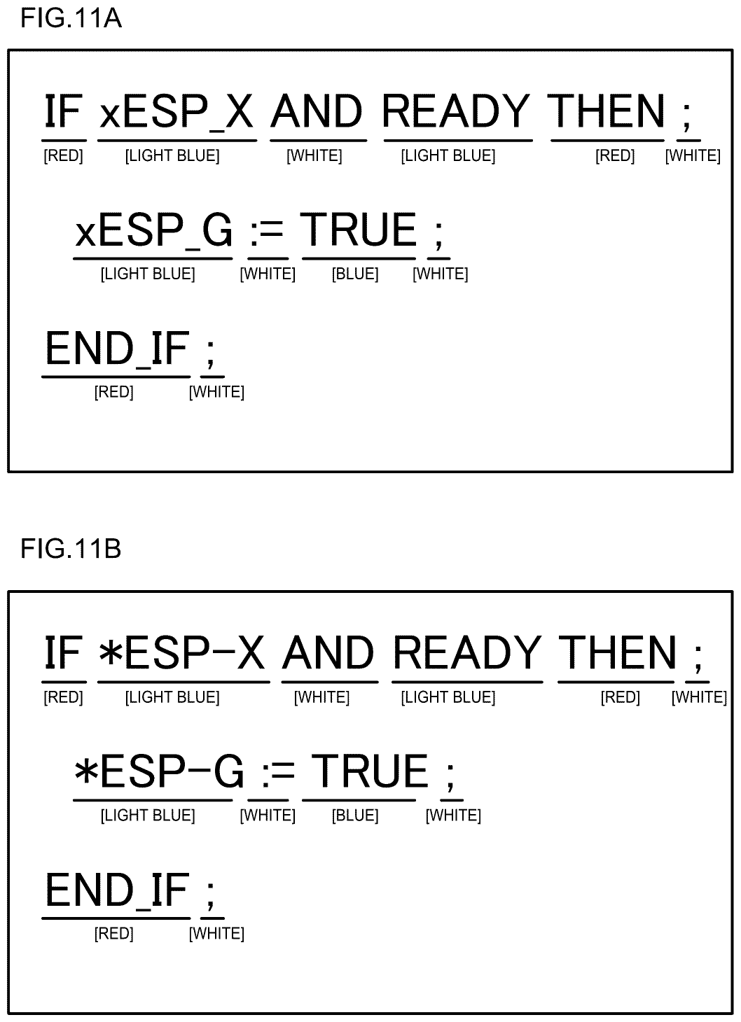

FIG. 11A shows an example of a display screen of the structured program using variable names.

In FIG. 11A, statements, such as “IF”, “THEN” and “END_IF”, are indicated in red, variables, such as “xESP_X”, “READY” and “xESP_G”, are indicated in light blue, operators, such as “:=”, are indicated in white, and reserved words, such as “TRUE”, are indicated in blue.

FIG. 11B shows an example of a display screen of a structured text program using symbol names. The name replacement unit 3 reads a correspondence table to replace the symbol names with the variable names. A symbol name “*ESP-X” is displayed in the display area of a variable name “xESP_X”, and a symbol name “*ESP-G” is displayed in the display area of a variable name “xESP_G”.

The display screen in FIG. 11B may visually points out that the symbol names are different from the variable names. For example, the background color can be changed in the display areas of the symbol names “*ESP-X” and “*ESP-G”. Pop-up display by mouseover may also be used to point out that the symbol names are different from the variable names.

As described above, the sequence program display device 100 of the second disclosure determines whether the name of an address (symbol name) input during editing the sequence program conforms to the IEC standards, and when the symbol name does not conform to the IEC standards, establishes a correspondence with a variable name that conforms to the IEC standards.

After establishing the correspondence between the input name of the address and the variable name, the sequence program display device 100 of the second disclosure rewrites the name of the address in the sequence program being edited into the corresponding variable name and stores the program in the program storage unit 5.

The sequence program display device 100 of the first disclosure and the sequence program display device 100 of the second disclosure include replacement tables to replace the symbol names with the variable names. The replacement of the symbol names with the variable names may be conducted automatically, or the replacement may be conducted in such a way that the candidate names for the replaced variable names are presented to a user to prompt the user to select the name.

The sequence program display device 100 of the first disclosure uses symbol names that are familiar to certain users to display a sequence program in order to improve the visibility of the program. For example, even when symbol names in an actual sequence program are replaced with variable names to conform to the IEC standards, the symbol names given during editing the program are displayed, so that a user can view the program without being bothered by the difference in the names.

The sequence program display device 100 of the second disclosure can establish the correspondences between the symbol names input at the same time the sequence program is edited and the variable names. In addition to that, once the correspondences are established, when a symbol name is input next time, the symbol name is replaced with a variable name automatically. Furthermore, the correspondences can also be established between symbol names and variable names for a sequence program created in the past to thereby rewrite the correspondent symbol names into the variable names.

The sequence program display device 100 of the second disclosure can replace symbol names in a sequence program to be stored in the program storage unit 5 with variable names with the symbol names being displayed on the edit screen of the sequence program. Since the edit screen of the sequence program displays the symbol names, the user can create a program without being bothered by the difference in the names. Furthermore, symbol names in the created sequence program are automatically rewritten into the variable names, thereby enabling program creation according to the IEC standards.

### Hardware Configuration

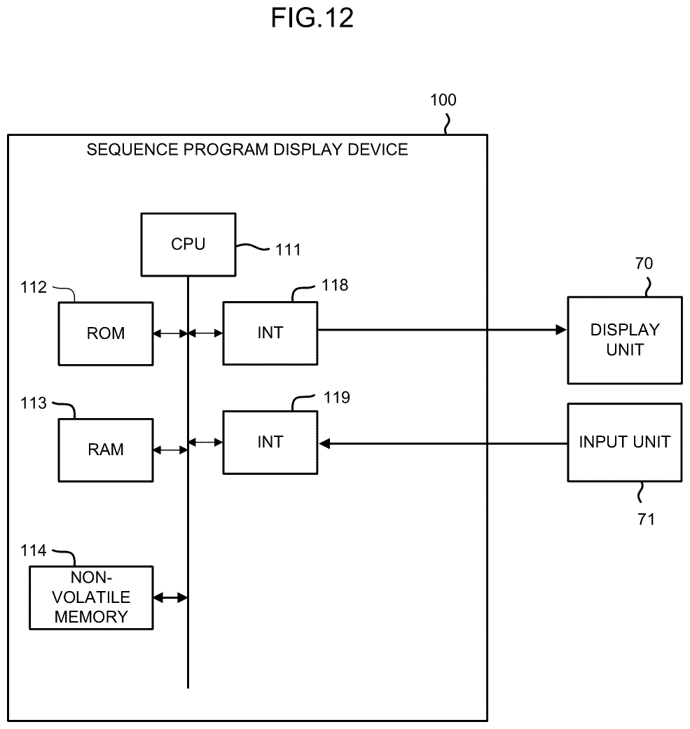

With reference to FIG. 12, a hardware configuration of the sequence program display device 100 will be described. The sequence program display device 100 includes a central processing unit (CPU) 111 that is a processor for controlling the entire sequence program display device 100. The CPU 111 reads a system program processed in a read-only memory (ROM) 112 via a bus to control the entire sequence program display device 100 according to the system program. A random-access memory (RAM) 113 is configured to temporarily store temporary computation data and pieces of data to be displayed, as well as various pieces of data input through an input unit 71 by a user.

A display unit 70 is a monitor attached to the sequence program display device 100. The display unit 70 is configured to display, such as, an operation screen and a setting screen of the sequence program display device 100.

The input unit 71 is a keyboard, a touch panel or similar which is integral with the display unit 70 or separate from the display unit 70. The user operates the input unit 71 to perform an input operation to a screen displayed on the display unit 70. The display unit 70 and the input unit 71 may be handheld devices.

A non-volatile memory 114 is, for example, a memory which is backed up by a battery not shown, so that storage conditions can be retained even when a power source of the sequence program display device 100 is turned off. The non-volatile memory 114 is configured to store workpiece shape data, tool geometry data, tool path data, and machining programs. The non-volatile memory 114 stores programs read from an external device via an interface not shown, programs input through the input unit 71, and various data acquired from each component of the sequence program display device 100, machine tools and others (e.g. setting parameters acquired from the machine tools). The programs and the various data stored in the non-volatile memory 114 may be deployed into the RAM 113 when they are executed/used. Furthermore, the ROM 112 stores various system programs in advance.

### REFERENCE SIGNS LIST

100 Sequence Program Display Device
1 Program Acquisition Unit
2 Program Display Unit
3 Name Replacement Unit
4 Name Storage Unit
5 Program Storage Unit
6 Editing Operation Acceptance Unit
7 Program Editing Unit
8 Name Management Unit
70 Display Unit
71 Input Unit
111 CPU
112 ROM
113 RAM
114 Non-Volatile Memory

1. A sequence program display device, comprising:
a name storage unit that stores correspondences between variable names conforming to first notation and symbol names conforming to second notation;
a program acquisition unit that acquires a sequence program described by the variable names conforming to the first notation;
a name replacement unit that replaces variable names included in the sequence program with the symbol names; and
a program display unit that displays the sequence program using the symbol names.

2. The sequence program display device according to claim 1, wherein the program acquisition unit is an editing operation acceptance unit for accepting an editing operation for the sequence program, and comprises
a name management unit that determines whether or not a symbol name accepted by the editing operation acceptance unit conforms to the first notation, and when the symbol name does not conform to the first notation, rewrites the symbol name in the sequence program being edited into a variable name that conforms to the first notation.

3. The sequence program display device according to claim 2, wherein the name management unit accepts a setting of a variable name corresponding to the symbol name accepted by the editing operation acceptance unit when the symbol name does not conform to the first notation, and stores the correspondence between the symbol name and the variable name in the name storage unit.

4. The sequence program display device according to claim 2, wherein the program acquisition unit is a program storage unit for storing an existing sequence program, and comprises
a name management unit that determines whether or not symbol names included in the existing sequence program conform to the first notation, and when the symbol names do not conform to the first notation, rewrites the symbol names in the existing sequence program into variable names that conform to the first notation.

5. The sequence program display device according to claim 4, wherein the name management unit accepts a setting of variable names corresponding to the symbol names included in the existing sequence program when the symbol names do not conform to the first notation, and stores the correspondences between the symbol names and the variable names in the name storage unit.

6. The sequence program display device according to claim 2, wherein the name management unit stores a replacement table between the first notation and the second notation, and uses the replacement table to replace the symbol names with the variable names.

7. The sequence program display device according to claim 1, wherein when variable names in the sequence program are replaced with the symbol names, the program display unit displays the symbol names to be displayed by decorating them.

8. The sequence program display device according to claim 1, wherein the sequence program can be written in a plurality of languages, and
the name replacement unit replaces variable names included in a sequence program written in a specific language with symbol names that conform to the second notation,
the program display unit then displays the sequence program written in the specific language with the symbol names.

9. A storage medium which stores commands readable by one or more processors, storing correspondences between variable names that conform to first notation and symbol names that conform to second notation,
the one or more processors executing the commands to:
acquire a sequence program described by variable names conforming to the first notation;
replace the variable names included in the sequence program with symbol names that conform to the second notation; and
display the sequence program in the symbol names conforming to the second notation.
